(19) United States
(12) Patent Application Publication
(10) Pub. No.: US 2005/0251377 A1
(43) Pub. Date: Nov. 10, 2005

(54) Circuit and electromagnetic simulator system and method

(75) Inventor: Jinsong Zhao, Milpitas, CA (US)

Correspondence Address: EMIL CHANG;LAW OFFICES OF EMIL CHANG, 874 JASMINE DRIVE, SUNNYDALE, CA, 94086, US

(73) Assignee: Lorentz Solution, Inc.

(21) Appl. No.: 11/070,050

(22) Filed: Mar. 1, 2005

Related U.S. Application Data
(60) Provisional application No. 60/568,312, filed on May 4, 2004.
(60) Provisional application No. 60/568,311, filed on May 4, 2004.

(51) Int. Cl. G06F 17/50

(52) U.S. Cl. 703/14

(57) ABSTRACT

The present invention provides methods and apparatuses for a circuit simulator that combines electromagnetic simulation. The method for circuit simulation comprises the steps generating a netlist having a plurality of current-voltage based elements and EM-elements, parsing the netlist to provide current-voltage based devices and EM-devices, matrix stamping each of the plurality of current-voltage based devices to derive a set of current-voltage based equations that adds values to connectivity-indexed matrix elements, deriving EM interface equations to model interactions among the EM-devices, deriving EM property equations to provide electromagnetic and connectivity properties of the EM-devices, and solving the current-voltage based equations, the EM interface equations and the EM property equations to provide an output.

### CROSS REFERENCE

This application claims priority from a provisional patent application entitled “Circuit-based Electromagnetic simulation for efficient high-frequency modeling” filed on May 4, 2004, having a Provisional Patent Application No. 60/568,312; and a provisional patent application entitled “Electromagnetically Enhaced Circuit Simulator” filed on May 4, 2004, having a Provisional Patent Application No. 60/568,311. These applications are incorporated herein by reference.

### FIELD

The present invention relates to circuit simulation and, more particularly, to methods and apparatuses for a circuit simulator to incorporate electromagnetic elements in circuit simulation.

### BACKGROUND

Traditionally, circuit simulators and electromagnetic simulators are separate tools used for separate purposes. As such, the ability to link the two simulators into a single electromagnetic circuit simulator is limited. Although, through the use of file transfers and cumbersome application programming interfaces, circuit designers have had limited results with circuit simulators incorporating electromagnetic simulations.

Most of today's circuit simulators are based on the SPICE circuit simulator developed at University of California at Berkeley. In general, the SPICE circuit simulator accepts an input file, typically called a netlist, which specifies devices in the circuit and their connectivities. The circuit simulator parses the netlist, constructs circuit equations based on the devices and their connectivities, and solves the circuit equations to produce a result that simulates circuit behavior with the devices. Circuit simulation enables circuit designers to design by computer simulation, thereby reducing the manufacturing cost incurred in product development. Accordingly, device models used in the simulation are very important in minimizing the differences between simulation results and physical measurement results.

With Spice and similar circuit simulators, each device is assumed to have no interaction with other devices except through the connectivities between the devices. The basic concepts used in the circuit simulator are node voltage and branch current. Device models are based on the relationships among interface currents and voltages. Recent circuit simulators have included non-linear simulation algorithms such as the incorporation of the harmonic balance method and the shooting method in an attempt to approximate high-frequency circuit behaviors in a circuit.

As device geometries steadily decrease and operating frequencies continue to increase in today's devices, traditional assumptions upon which the circuit simulator was developed are no longer valid. In particular, there are two shortcomings for circuit simulation at high frequencies. First, models for individual passive devices, such as inductor, capacitor, resistor and distributed components, are not self-contained and actually change due to the presence of adjacent devices. Second, the assumption that each device has no interaction with other devices except through the connectivities is no longer valid for accurate simulation. Passive devices and interconnects have complex electromagnetic couplings and interactions. Without including the theory of electromagnetics in the circuit simulation, the results of the simulation can be highly inaccurate when compared to the physical circuit.

General-purpose electromagnetic simulators, which may use frequency-domain and time-domain simulation methods (FDTD), such as method of moments, or finite-element method, use very different concepts than those used in circuit simulation, and thus are considered to be in a different category from circuit simulators. For example, to account for electromagnetics in a circuit simulator for an individual passive device, a circuit designer would use a separate electromagnetic simulator and go through a series of complex steps to enter the geometries and material properties of the passive device, obtain network parameters out of the electromagnetic simulation, and convert the output data into a format that is compatible with the circuit simulator. This approach does not consider the interactions of multiple passive devices. Moreover, incompatibilities between the electromagnetic simulators and the circuit simulators require complex file transfers that are unproductive and unintuitive for circuit designers. The different concepts involved in an electromagnetic simulation and circuit simulation adds further inconvenience into the design process. Furthermore, the traditional electromagnetic simulation is much slower than the circuit simulation which also reduces the desirability and efficiency of integration of the two types of simulations.

Even with recent attempts to combine electromagnetic simulation and circuit simulation such as the Green's functions and the surface-based electromagnetic formulation, these attempts have limited applicability in semiconductor circuit design. For instance, the Green's functions apply to the free-space Green's functions, making their applicability for semiconductor circuit design inconvenient, while the surface-based electromagnetic formulation is restrictive and applies to a limited set of 2.5 D applications.

Although progress has been made to improve the accuracy of circuit simulation by attempting to include the theory of electromagnetics as a part of the circuit simulation, these attempts are restricted to certain applications, and are cumbersome, complex, and unproductive. Accordingly, there is a need for an improved circuit simulator method and apparatus which combine electromagnetic simulation and circuit simulation into a single application.

### SUMMARY OF THE INVENTION

The present invention provides an enhanced circuit simulator with electromagnetic simulation to improve the overall accuracy of circuit simulation. The novel electromagnetic (EM) enhanced circuit simulator is based on incorporating a novel EM netlist and an EM interface for linking to existing circuit simulators. Thus, according to one aspect of the invention, the method for the circuit simulator comprises the steps of defining a netlist having a plurality of current-voltage based elements and EM-elements, parsing the netlist to provide current-voltage based devices and EM-devices, matrix stamping each of the plurality of current-voltage based devices to derive a set of current-voltage based equations that adds values to connectivity-indexed matrix elements, deriving EM interface equations to model interactions among the EM-devices, deriving EM property equations to provide electromagnetic and connectivity properties of the EM-devices, and solving the current-voltage based equations, the EM interface equations and the EM property equations to provide an output.

According to one aspect of the invention, the step of matrix stamping includes the step of deriving one or more equations based on Kirchhoff's current law and Kirchhoff's voltage law.

According to another aspect of the invention, the step of solving includes the step of concurrently solving the current-voltage based equations, the EM interface equations, and the EM property equations.

According to a further aspect of the invention, the method further comprises the step of pre-processing the EM elements to obtain a result and integrating the result with the current-voltage based equations to obtain the output.

In yet another aspect of the invention, the step of pre-processing includes the steps of deriving EM interface equations to model interactions among the EM-devices, deriving EM property equations to provide electromagnetic and connectivity properties of the EM-devices, and solving the EM interface equations and the EM property equations to obtain the result.

Other aspects and advantages of the present invention will become apparent to those skilled in the art from reading the following detailed description when taken in conjunction with the accompanying drawings.

### BRIEF DESCRIPTION OF THE DRAWINGS

FIG. 1 is an illustration of an example cross-section structure in accordance with an embodiment of the present invention;

FIG. 2 is an illustration of a square spiral inductor electromagnetic device;

FIG. 3 is an architecture block diagram of an electromagnetically enhanced circuit simulator in accordance with an embodiment of the present invention;

FIG. 4 is a flow diagram showing the data flow of the electromagnetically enhanced circuit simulator in accordance with an embodiment of the present invention;

FIG. 5 is an illustration of discretizing a conductor into electromagnetic basic elements in accordance with an embodiment of the present invention;

FIG. 6 is an illustration of an edge current element in accordance with an embodiment of the present invention; and

FIG. 7 is a circuit diagram representation of an example netlist in accordance with an embodiment of the present invention.

### DETAILED DESCRIPTION

As described below, the present invention provides methods and apparatuses for an electromagnetically enhanced circuit simulator or EM-enhanced circuit simulator. The invention can be used with traditional SPICE circuit simulators and combines electromagnetic simulation to provide more accurate circuit simulation results. Generally, the EM-enhanced circuit simulator extends a normal circuit simulator with the capability of simulating devices whose behaviors are described by underlying electromagnetic equations. The electromagnetic equations apply both to individual devices and to the couplings among those devices. The EM-enhanced circuit simulator extends support for traditional current-voltage based models, such as lumped resistor, inductor, capacitor, transmission lines, linear controlled sources and semiconductor devices, etc. More importantly, the EM-enhanced circuit simulator includes EM-devices as part of the traditional current-voltage based supported devices. Models of the EM-devices and their device couplings are computed through equations based on electromagnetics. These equations can either be solved separately or bundled in the entire system equations.

According to an embodiment of the present invention, the EM-enhanced circuit simulator includes an enhanced netlist that supports EM-devices for convenient specification and instantiation. The enhanced netlist supports the specification for the process information and material properties.

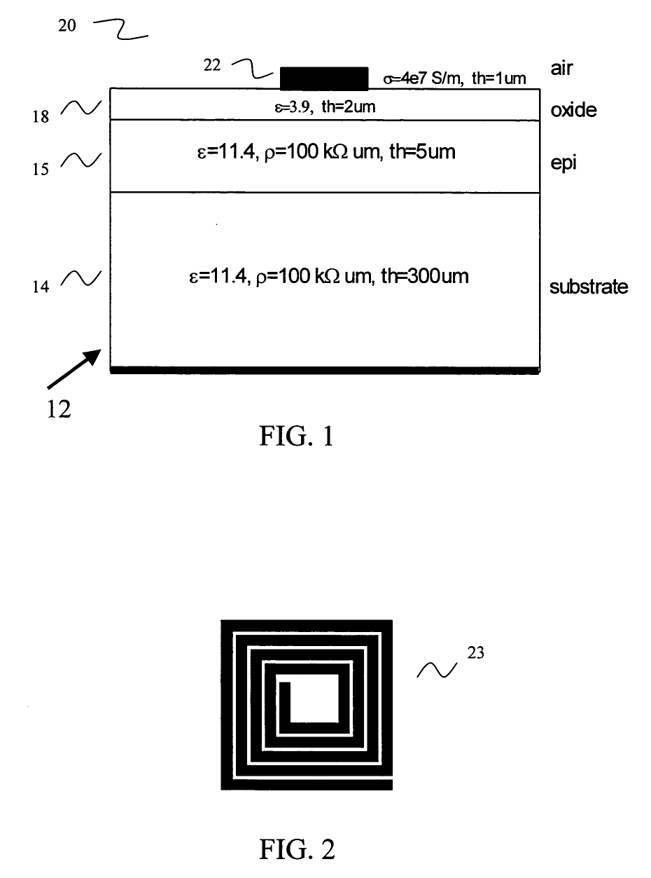

Referring to FIG. 1, an illustration of an example cross-section structure 12 is shown. Those skilled in the art of circuit simulation will recognize similarity in the format of the netlist profile statement which is listed as follows:

.profile k=[11.4 11.4 3.9 1] sigma=[10000 10 0 0] th=[300u 5u 2u 0] mname=[m1] msigma=[4e7] mh=[307u] mth=[1u]

The .profile statement specifies the cross-section profile of a simplified process structure 12 as shown in FIG. 1. The structure is abstracted into 4 non-metal layers and one metal layer. The non-metal layers are substrate 14, epi 15, oxide 18, and air 20. The metal layer is shown as layer 22. The definition for each parameter for the .profile statement is as follows:
k: the dielectric constant for the non-metal layers
sigma: conductivity for non-metal layers (ρ=1/σ)
th: thickness of each non-metal layer. 0 means extending to infinity
mname: metal layer names, to be used by instances
msigma: metal layer conductivity
mh: metal layer vertical position relative to the backplane
mth: metal layer thickness.

Different circuit simulators may have different netlist formats of specifying devices or components and their connectivities. However, in general, a netlist includes one or more devices, wherein each device is specified by its parameters and connectivities. The EM-enhanced circuit simulator supports EM-devices, which are devices that are modeled based on electromagnetic equations. Referring to FIG. 2, a square spiral inductor EM device 23 is shown. While different implementations may vary, one such example to define a device for the square inductor EM device 23 is as follows:

spiral_Square(1 0) outlen=200u width=12.8u spacing=4u nseg=18 layer=m1

The device model is a “spiral_square”, which has two nodes for connection, node 1 and node 0. In this example, the square spiral inductor EM device 23 has a set of parameters, such as “outlen”, “width”, “spacing”, “nseg”, and “layer”. The parameters specify a square spiral inductor constructed on layer “m1” with outside length of 200 um, wire width of 12.8 um, and wire spacing of 4 um, and the spiral conductor contains 18 segments.

The EM-enhanced circuit simulator also supports similar passive devices, such as circular spirals, transformers, and other inductors made up of winding conductors to form high inductance. In addition, the EM-enhanced circuit simulator supports passive structures such as bonding pads, interconnects, and vias. These supported devices and structures are built-in models that can be accessed by the circuit designer for simulation. Other device support includes primitive electromagnetic elements, such as path, line, and polygon. Primitive EM-elements are building blocks to construct more complicated structures and extends the capability of the EM-enhanced circuit simulator.

Moreover, as a superset of traditional electronic circuit simulators, the EM-enhanced circuit simulator supports the mix of traditional circuit elements and EM-devices. Consider the following example netlist statement for a spiral square and a resistor:

spiral_square(1 0) outlen=200u width=12.8u spacing=4u nseg=18 layer=m1
resistor(1 2)r=100

In the above example, the square spiral inductor and the resistor share one node, “1”, and resistor has a resistance value of 100. Those skilled in the art of circuit simulation will appreciate that the netlist statement for an EM-device uses similar format as those used for traditional circuit devices. A netlist can have one or more EM-devices, and these EM-devices can be either fully electromagnetically coupled, or selectively coupled through switches in the EM-device instance parameters.

The passive device models of the EM-enhanced circuit simulator greatly improve the efficiency of numerical implementation for electromagnetic simulations by taking into account the geometry and current direction.

In operation, the EM-enhanced circuit simulator reads the EM-device models. Each EM-device model is a supported device at the netlist level so that a circuit designer can directly use the EM-device model by using a proper instance statement in the netlist. Internally, the EM-device is discretized into EM-elements which represent the basic building elements for the electromagnetic equations. Electromagnetic equations have many varieties. According to an embodiment of the present invention, the electromagnetic equations can be derived from Method of Moments.

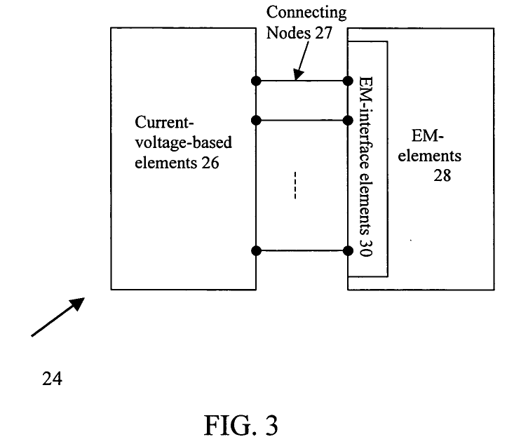

FIG. 3 represents a block diagram of the EM-enhanced circuit simulator 24, and illustrates the relationship between the current-voltage based elements 26 and the EM-elements 28. Connecting nodes 27 couple the current-voltage based elements 26 with the EM-elements 28. The current-voltage based elements 26 have equations derived from modified nodal analysis. According to an embodiment of the present invention, the EM-elements 28 have equations derived from electromagnetic analysis, including Method of Moments. The EM-interface elements 30 represent an interface between the electromagnetic equations and nodal equations. The EM-interface elements 30 have EM interactions with EM-elements 28 and include voltage and current properties. In accordance with an embodiment of the present invention, the total current flowing into the connecting node from both the EM-interface elements and current-voltage based elements is zero, and that the voltage on the connecting node is the same at current-voltage based elements side and at the EM-interface elements side. In accounting for the current flowing into the connecting node to be zero and the voltage on the connecting node to be the same at the current-voltage based elements side and at the EM-interface elements side, compatibility with existing circuit simulators are maintained.

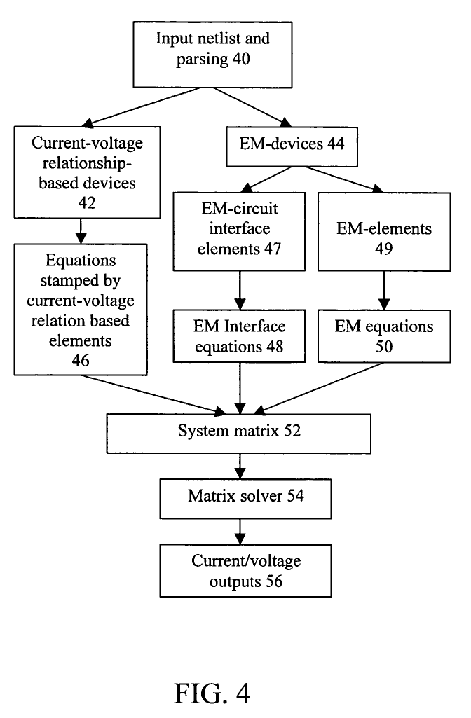

According to an embodiment of the present invention, a data flow diagram of the EM-enhanced circuit simulator is shown in FIG. 4. The data flow diagram begins with step 40 with the EM enhanced simulator reading in input devices of the circuit to be simulated and parsing a netlist containing the EM-devices. The input devices are separated into two types: current-voltage relationship-based devices 42 and EM-devices 44. The EM-devices 44 are decomposed into EM-circuit interface elements 47 and EM-elements 49. Next, equations corresponding to the current-voltage relationship-based devices, EM-circuit interface elements, and EM-elements are constructed. Three sets of equations are constructed into a single system matrix. The first set is the SPICE-like equations 46 based on Kirchhoff's Current Law (KCL) and Kirchhoff's Voltage Law, implemented through the matrix stamping method in which each current-voltage relationship-based device (such as lumped resistor, lumped inductor, etc) contributes to the system matrix by adding values to connectivity-indexed matrix elements. These equations are handled similarly as traditional circuit simulators.

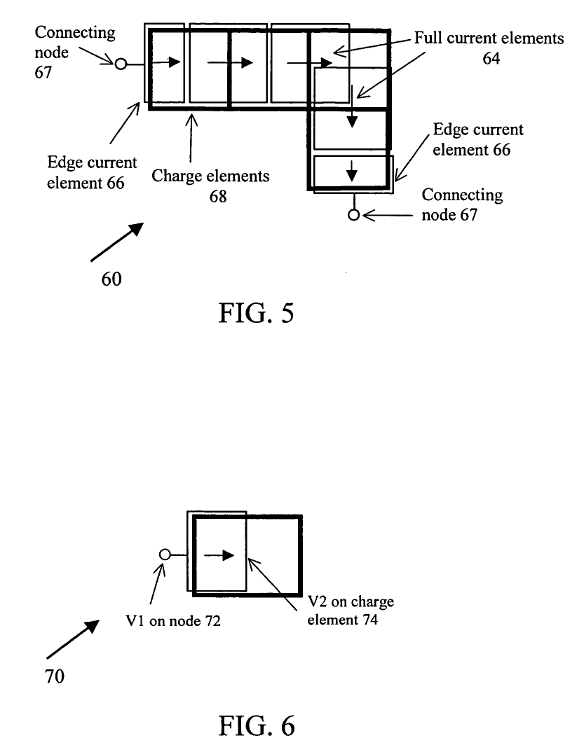

The second set is the EM interface equations 48 that implement the interactions between electromagnetic elements and regular circuit elements. The electromagnetic parameters, such as current density, charge distribution and scalar potential, are mapped to circuit parameters such as node voltage and branch current. At the nodes that connect the EM-circuit interface elements and regular circuit simulator devices, the KCL is enforced to derive this set of EM interface equations. The third set is EM equations 50 that include electromagnetic couplings among EM elements. An embodiment of the present invention which derives the EM interface equations 48 and EM equations 50 based on Mixed Potential Equation formulation is disclosed with respect to FIG. 5 and FIG. 6. The three sets of equations are combined into a system matrix in step 52. In accordance with an embodiment of the present invention, a matrix solver 54 solves the three sets of equations concurrently and provides current and voltage outputs in step 56. Accordingly, interactions between current-voltage devices and EM-devices are accounted for, and interactions among EM-elements are computed.

As disclosed, an embodiment of the present invention for implementation of electromagnetic elements is based on Mixed Potential Integral Equation formulation and the Method of Moments numerical solving. A conductor is discretized into many segments based on accuracy requirement of the EM-enhanced circuit simulator. FIG. 5 illustrates an example of a discretized conductor 60 having a plurality of electromagnetic (EM) basic elements 64, 66, 67, and 68 which includes EM-circuit interface elements 47 and EM-elements 49. The discretized conductor 60 includes a full current element 64, an edge current element 66, and charge element 68. The full current element 64 and charge element 68 correspond to EM-elements 49 for the derivation of EM equations 50. The edge current element 66 is an EM-interface element and is a connecting point from connecting node 67 to the electromagnetic equation system or EM equations 50.

Assuming an EM formulation system in which unknowns are the current densities of full current elements N_{f}, current density of half current elements Nₕ (h represents for half), and charge density of charge elements N_{q}, and finding N_{f}+N_{q}+Nₕ equations to solve the system matrix, the first N_{f}+N_{q} equations are constructed based on N_{f}+N_{q} full current elements and charge elements under typical fullwave formulation. These equations do not interact with external circuit nodes. The next Nₕ equations are constructed based on Nₕ unknowns for the edge current elements using the methods described with respect to FIG. 6.

FIG. 6 shows an edge current element of an EM-interface element 70 that has one end connected to a connecting node 72, and other end overlaps with the center of charge element 74. The voltage on the charge element is V2, and the voltage on the node is V1. Assuming the edge current element is the ith current element, the contribution of the edge current elements to system matrix is described below.

For the equation related to this edge current element, the voltage drop, V₁−V₂, should be the same as the total voltage contribution of ohmic voltage drop and inductive voltage drop, i.e.,

$${V}_{1} - {V}_{2} = {R}_{i} {J}_{i} + j ω {\sum }_{j} {L}_{ij} {J}_{j}$$

expressed in frequency domain, where Rᵢ is the resistance along the current direction of the edge current element, Jⱼ is the jth current element, and Lᵢⱼ is the mutual inductance from jth current element to ith current element. In time domain, the contribution by current elements can be expressed in terms of corresponding convolution and derivative operations.

For the equation related to KCL on the charge element, the KCL equation for the charge element needs to add a negative coefficient corresponding to Jᵢ. The negative sign is due to the fact that the current flows into the charge element.

For the equation related to KCL on the connecting node, the KCL equation for the corresponding node needs to add a positive coefficient corresponding to Jᵢ. The positive sign is due to the fact that the current flows out of the connecting node.

There are several varieties under the same architecture design of the EM-enhanced circuit simulator, and some of them are listed as follows.

The present disclosure on the internals of the EM-enhanced circuit simulator applies to both frequency-domain and time-domain simulations. Techniques, such as time-domain numerical convolution or time-domain reduced-order models, can be used to implement the electromagnetic contributions into the circuit equations.

EM equations may be applied after the electromagnetic system has been approximated and simplified. The pre-processing of the electromagnetic equations leads to added efficiency of the electromagnetic simulation with no difficulty in integrating into the circuit simulation. Accordingly, the processing of the EM-devices, the equations setup, and pre-processing of electromagnetic system are not restricted to the single CPU or machine on which the circuit simulation runs. These tasks can be done through parallel processing on an SMP machine or a networked computing device.

The present invention enhances traditional electronic circuit simulators, including those with periodic steady-state analysis type. The enhanced circuit simulator provides convenient capability of electromagnetic modeling and simulation. The consistent input format of the electromagnetic device and overall consistent architecture design provides for incorporation of electromagnetic devices into a circuit simulator. Accordingly, the present invention affords simulation of passive devices such as inductors, transformers, and transmission lines, passive structures including interconnects and their electromagnetic couplings for semiconductor and printed circuit board together with traditional circuit devices in a consistent and familiar circuit design format and environment.

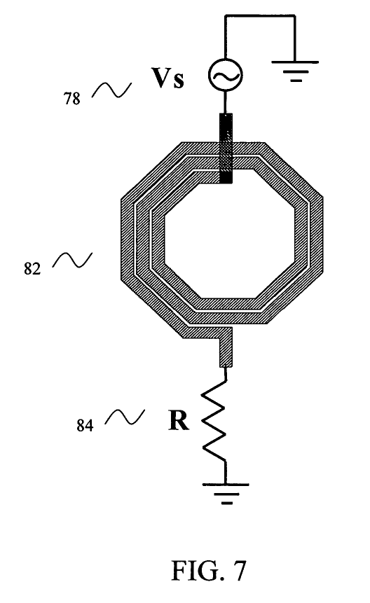

The following Listing is an example netlist in accordance with an embodiment of the present invention. FIG. 7 is a circuit diagram representation of the example netlist illustrating an octagonal spiral 82 connected between voltage source 78 and a resistor 84.

Netlist Listing

# This is a sample netlist used by an embodiment of EM-enhanced
# circuit simulator
# Pound sign “#” is for comments
# options to control EM and circuit simulations such as convergence
control
.option nu=2, nv=2
# Silicon profile description
.profile k=[11.7, 4.2, 4.2, 4.2, 1.0], sigma=[6000, 0.0, 0.0, 0.0, 0.0],
th=[300u, 4u,2u, 2u, 0], msigma=[3.27e7, 3.27e7, 3.27e7, 3.27e7],
mname=[sub, m1, m4,m5], mth=[0, 0.7u, 0.7u, 1u], mh=[300u, 304u,
306u, 308u]
# The EM-devices: octagonal spiral and connecting lines,
# with their instance names as “i1”, “i2”, and “i3”
# EM devices have their EM couplings computed, and they further
interact with
# rest of circuit through nodes 1, 2, 3, and 4.
i1(1, 2) spiral_octagon inlen=200u, width=20u, spacing=5u, nturn=2.5,
layer=m5, move=[250u, 264u]
i2(1, 3) line width=20u, length=110u, layer=m4, rotate=90
i3(2, 4) line width=20u, length=60u, layer=m5, rotate=−90
# Regular SPICE devices: resistor (“i4”) and voltage source (“v1”)
i4(4, 0) resistor r=50
v1(1, 0) vsource
# Define output ports and output files:
# S parameter file and SPICE equivalent circuit
.net port=[v1], sfile=structure.s2p, cktfile=structure.cir
# Frequency range from 0.1GHz to 20GHz with 50 points linearly
sampled
.ac lin=[50, 0.1g, 20g]
# End of netlist
.end
**********

While the foregoing detailed description has described several embodiments of the present invention, it is to be understood that the above description is illustrative only and not limiting of the disclosed invention. Obviously, many modifications and variations will be apparent to those skilled in the art without departing from the spirit of the invention.

1. A method for simulating a circuit, comprising the steps:
defining a netlist having a plurality of current-voltage based elements and EM-elements;
parsing the netlist to provide current-voltage based devices and EM-devices;
matrix stamping each of the plurality of current-voltage based devices to derive current-voltage based equations;
decomposing EM-devices into EM-elements and EM-circuit interface elements;
deriving EM property equations to model interactions among the EM-elements and EM-circuit interface elements;
deriving EM interface equations to provide electromagnetic and connectivity properties of the EM-elements; and
solving the current-voltage based equations, the EM interface equations and the EM property equations to provide an output.

2. The method according to claim 1, wherein the matrix stamping step includes deriving equations based on Kirchhoff's current law and Kirchhoff's voltage law.

3. The method according to claim 1, wherein the solving step includes concurrently solving the current-voltage based equations, the EM interface equations, and the EM property equations.

4. The method according to claim 1, wherein the EM elements are based on Mixed-Potential Integral Equation formulation and the solving step includes the use of the Method of Moments numerical solving.

5. The method according to claim 1 further including pre-processing the EM elements to obtain a result and integrating the result with the current-voltage based equations to obtain the output.

6. The method according to claim 5, wherein the step of pre-processing includes:
deriving EM interface equations to model interactions among the EM-devices;
deriving EM property equations to provide electromagnetic and connectivity properties of the EM-devices; and
solving the EM interface equations and the EM property equations to obtain an EM result.

7. The method according to claim 1, wherein the step of solving the current-voltage based equations, the EM interface equations and the EM property equations applies to frequency-domain and time-domain simulations.

8. The method according to claim 1, wherein the step of solving the current-voltage based equations, the EM interface equations and the EM property equations applies to periodic steady-state analysis.

9. The method according to claim 1, wherein the step of deriving EM interface equation includes the use of the Method the Moments.

10. The method according to claim 1 wherein said following steps are dynamically loaded as a separate module:
decomposing EM-devices into EM-elements and EM-circuit interface elements;
deriving EM property equations to model interactions among the EM-elements and EM-circuit interface elements; and
deriving EM interface equations to provide electromagnetic and connectivity properties of the EM-elements.

11. The method according to claim 1, wherein said following steps are performed on a separate computer:
decomposing EM-devices into EM-elements and EM-circuit interface elements;
deriving EM property equations to model interactions among the EM-elements and EM-circuit interface elements; and
deriving EM interface equations to provide electromagnetic and connectivity properties of the EM-elements.

12. A netlist statement having a plurality of fields for an EM enhanced circuit simulator, comprising:
an EM device instance including:
a device name field to specify the EM device instance for the EM enhanced circuit simulator;
a node field to specify a nodal connection for the EM device instance; and
at least one field to specify a physical structure and layout for the EM device instance.

13. The netlist statement of claim 12 further comprising:
a process statement to specify a cross-section of a process structure including non-metal and conductor layers for circuit simulation, including:
a dielectric constant field to specify a dielectric constant for each non-metal layer;
a first conductivity field to specify a conductivity for each non-metal layer;
a first thickness field to specify a thickness for each non-metal layer;
a name field to specify a name for each conductor layer;
a second conductivity field to specify conductivity for each conductor layer;
a position field to specify each conductor layer relative to a position; and
a second thickness field to specify each conductor layer thickness.

14. The netlist statement of claim 13, wherein the cross-section of the process structure specifies a substrate layer, at least one dielectric layer, and at least one conductor layer.

15. An electromagnetic circuit simulator comprising:
means for processing a plurality of current-voltage based elements;
means for processing a plurality of EM-elements; and
means for processing a plurality of EM-interface elements coupled to the plurality of current-voltage based elements and the plurality of the EM-elements wherein the EM-interface elements include properties to interact with the EM-elements and the current-voltage based elements.

16. The electromagnetic circuit simulator according to claim 15, wherein each EM-interface element includes a condition that total current flowing into a connecting node from an EM-interface and a current-voltage based element is zero.

17. The electromagnetic circuit simulator according to claim 15, wherein each EM-interface element includes a condition that voltage at a connecting node for a current-voltage based element and the connecting node for an EM-element is equal.

18. The electromagnetic circuit simulator according to claim 15, wherein the current-voltage based elements include equations derived from modified nodal analysis.

19. The electromagnetic circuit simulator according to claim 15, wherein the EM-elements include equations derived from electromagnetic analysis.

20. The electromagnetic circuit simulator according to claim 19, wherein the electromagnetic analysis includes method of moments.
